(19) United States
(12) Patent Application Publication
(10) Pub. No.: US 2026/0008900 A1
(43) Pub. Date: Jan. 8, 2026

(54) RUBBER ASPHALT-DERIVED VOLATILE ORGANIC COMPOUNDS (VOCs) INHIBITOR BASED ON METAL ORGANIC FRAMEWORKS (MOFs) MATERIAL AND PREPARATION METHOD THEREOF, AND SMOKE-SUPPRESSION RUBBER ASPHALT AND PREPARATION METHOD THEREOF

(71) Applicant: Wuhan University of Technology, Wuhan City (CN)

(72) Inventors: Shaopeng WU, Wuhan City (CN); Yang Lv, Wuhan City (CN); Na LI, Wuhan City (CN); Jun XIE, Wuhan City (CN); Quantao LIU, Wuhan City (CN); Anqi CHEN, Wuhan City (CN); Huan WANG, Wuhan City (CN)

(21) Appl. No.: 18/763,314

(22) Filed: Jul. 3, 2024

(51) Int. Cl. C08K 5/00; B01J 20/22; B01J 20/28; B01J 20/30; C08L 95/00

(52) U.S. Cl. CPC C08K 5/0091; B01J 20/226; B01J 20/28004; B01J 20/28064; B01J 20/28066; B01J 20/28083; B01J 20/3085; C08L 95/00; C08K 2201/006

(57) ABSTRACT

Disclosed are a rubber asphalt-derived volatile organic compounds (VOCs) inhibitor based on a metal organic frameworks (MOFs) material and a preparation method thereof, and a smoke-suppression rubber asphalt and a preparation method thereof. The inhibitor has a chemical formula of CₓH_{y}O₃₂Zr₆, where x is in a range of 48 to 120, and y is in a range of 28 to 76; and the inhibitor is a zirconium-based MOFs material having a cubic crystal structure with a crystal pore size of 0.5 nm to 2 nm and a specific surface area of 1,000 m²/g to 3,200 m²/g.

### TECHNICAL FIELD

The present disclosure belongs to the technical field of rubber asphalt-derived volatile organic compounds (VOCs) inhibition, and more specifically relates to a rubber asphalt-derived volatile organic compounds (VOCs) inhibitor based on a metal organic frameworks (MOFs) material and a preparation method thereof, and a smoke-suppression rubber asphalt and a preparation method thereof.

### BACKGROUND OF THE INVENTION

With the rapid development of automobile industry, approximately 1.5 billion tires are produced globally every year and continue to grow at a high rate, posing severe challenges to the environment. An increasing number of waste rubber products has caused waste rubber to gradually become the largest solid waste residue in the world, and its disposal gradually becomes a burden for social and environmental governance. The further preparation of rubber powder into rubber asphalt shows significant economic benefits. This process is an internationally-recognized method for resource utilization and harmless treatment of waste tires as well as a key means to improve the performance of traditional petroleum asphalt.

However, compared to ordinary matrix asphalt, the rubber asphalt has a higher viscosity and a higher temperature during preparation and construction. Moreover, the volatile organic compounds (VOCs) released are more diverse and larger in quantity. Rubber asphalt can generate more than 100 types of VOCs during the preparation and on-site construction, and these VOCs have caused serious harm to human health and environment due to their low boiling points and easy volatilization properties. Class I carcinogens such as 1,3-butadiene, benzene, trichlorethylene, and 1,2-dichloropropane are the key VOCs that need to be suppressed. In view of the potential harm of asphalt-derived VOCs to the human body and environment, domestic and foreign researchers have done some research work on VOCs inhibition, which is of great significance in reducing the release of asphalt-derived VOCs.

However, the current VOCs inhibitors mainly adopt inorganic porous materials, which have low selectivity and low VOCs inhibition efficiency and are not conducive to the promotion of practical engineering applications. Chinese Patent CN114773635A discloses low-VOCs rubber particles, a rubber asphalt, and a preparation method thereof, where waterborne polyurethane, waterborne epoxy resin, or SBS emulsion is used to wrap the surface of a rubber powder to obtain the low-VOCs rubber particles and the rubber asphalt. However, the rubber particles prepared by this method each have a low specific surface area and a poor reactivity, and do not show an obvious inhibitory effect on rubber asphalt-derived VOCs at this stage.

In addition, the Chinese patent CN110294864A, entitled “Asphalt-derived VOCs inhibitor based on waste fluid catalytic cracking (FCC) spent catalyst, smoke-inhibited asphalt and preparation method thereof”, discloses that a porous molecular sieve structure on the surface of an FCC spent catalyst can be utilized to adsorb small-molecular substances in asphalt. However, the FCC spent catalyst contains heavy metal ions that cause pollutions to the soil, groundwater, and atmosphere. Therefore, the research on an environmental-friendly, and efficient rubber asphalt-derived VOCs inhibitor can help reduce the release of asphalt-derived VOCs, and is of great significance to human health and environmental protection.

### SUMMARY OF THE INVENTION

In view of the above defects or improvement requirements of the existing technology, the present disclosure provides a rubber asphalt-derived volatile organic compounds (VOCs) inhibitor based on a metal organic frameworks (MOFs) material and a preparation method thereof, and a smoke-suppression rubber asphalt and a preparation method thereof. An object of the present disclosure is to prepare a zirconium-based MOFs material with a cubic crystal structure by using any one of terephthalic acid, biphenyl-4,4′-dicarboxylic acid, and [1,1′:3′,1″-terphenyl]-4,4″-dicarboxylic acid as an organic ligand, and then adding zirconium chloride and the organic ligand at a molar ratio of 1:(1-6). The zirconium-based MOFs material has a chemical formula of CₓH_{y}O₃₂Zr₆, wherein x is in a range of 48 to 120, and y is in a range of 28 to 76; and the zirconium-based MOFs material has a crystal pore size of 0.5 nm to 2 nm and a specific surface area of (1,000-3,200) m²/g. It is found that materials with this pore size can well absorb VOCs in rubber asphalt and reduce a concentration of the VOCs, and has an excellent adsorption effect especially on 1,3-butadiene, benzene, trichlorethylene, and 1,2-dichloropropane. This indicates that the inhibitor can significantly inhibit the release of class I carcinogens, thus solving the technical problem that existing VOCs inhibitors have a poor inhibitory effect on the release of rubber asphalt VOCs.

To achieve the above object, according to one aspect of the present disclosure, provided is a rubber asphalt-derived VOCs inhibitor based on a MOFs material, where the rubber asphalt-derived VOCs inhibitor has a chemical formula of CₓH_{y}O₃₂Zr₆, x being in a range of 48 to 120, and y being in a range of 28 to 76; and the rubber asphalt-derived VOCs inhibitor is a zirconium-based MOFs material of a cubic crystal structure having a crystal pore size of 0.5 nm to 2 nm and a specific surface area of 1,000 m²/g to 3,200 m²/g.

In some embodiments, the zirconium-based MOFs material has a crystal appearance with a size of 100 nm to 3.0 μm, the crystal pore size of 1 nm to 2 nm, and the specific surface area of 2,000 m²/g to 3,200 m²/g.

According to another aspect of the present disclosure, provided is a method for preparing the rubber asphalt-derived VOCs inhibitor based on a MOFs material, including the following steps:
adding zirconium chloride into N,N-dimethylformamide (DMF), stirring at a constant temperature, separately adding an organic ligand and acetic acid, and stirring at a constant temperature to obtain a mixed solution; and
subjecting the mixed solution to reaction at a temperature of 100° C. to 160° C. for 12 h to 24 h to obtain a reaction product, and naturally cooling the reaction product to room temperature; washing the reaction product by centrifugation with DMF and methanol multiple times to obtain a precipitate, and drying the precipitate to obtain the rubber asphalt-derived VOCs inhibitor based on a MOFs material; where
the zirconium chloride, the DMF, the organic ligand, and the acetic acid are added at a molar ratio of 1:(400-600):(1-6):(5-105); and
the organic ligand includes one or a combination of two or more selected from the group consisting of terephthalic acid, biphenyl-4,4′-dicarboxylic acid, and [1,1′:3′,1″-terphenyl]-4,4″-dicarboxylic acid.

In some embodiments, the terephthalic acid contians greater than or equal to 98.0 wt % of C₈H₆O₄, the biphenyl-4,4′-dicarboxylic acid contains greater than or equal to 97.0 wt % of C₁₄H₁₀O₄, and the [1,1′:3′,1″-terphenyl]-4,4″-dicarboxylic acid contains greater than or equal to 98.0 wt % of C₂₀H₁₄O₄; and the acetic acid contains greater than or equal to 99.5 wt % of CH₃COOH.

In some embodiments, the acetic acid is added at a flow rate of 1 mL/min to 10 mL/min.

In some embodiments, when the zirconium chloride is added into the DMF, the stirring is conducted at the constant temperature of 30° C. to 80° C. for 15 min to 30 min; when the organic ligand is added, the stirring is conducted at the constant temperature of 20° C. to 60° C. for 15 min to 30 min; and when the acetic acid is added, the stirring is conducted at the constant temperature of 40° C. to 60° C. for 30 min to 60 min.

According to another aspect of the present disclosure, provided is use of the rubber asphalt-derived VOCs inhibitor based on the MOFs material in adsorption of VOCs derived from a rubber asphalt.

In some embodiments, the VOCs derived from the rubber asphalt includes 1,3-butadiene, benzene, trichlorethylene, and 1,2-dichloropropane.

According to another aspect of the present disclosure, provided is a smoke-suppression rubber asphalt, including the following components in parts by mass: 70 parts to 90 parts of an asphalt, 10 parts to 30 parts of a rubber powder, and 0.1 parts to 1 part of the rubber asphalt-derived VOCs inhibitor based on the MOFs material of the present disclosure.

In some embodiments, the smoke-suppression rubber asphalt is prepared by a method including the following steps:
mixing 70 parts to 90 parts of the asphalt at a temperature of 160° C. to 170° C. as a matrix with 10 parts to 30 parts of the rubber powder, and shearing at a shearing speed of 4,000 r/min to 8,000 r/min for 40 min to 60 min to obtain a rubber asphalt; and
adding 0.1 parts to 1 part of the rubber asphalt-derived VOCs inhibitor based on the MOFs material of the present disclosure into the rubber asphalt, and shearing at a shearing speed of 4,000 r/min to 8,000 r/min for 20 min to 40 min at a constant temperature of 160° C. to 170° C. to obtain the smoke-suppression rubber asphalt.

Compared with the prior art, the above rubber asphalt-derived VOCs inhibitor conceived by the present disclosure can achieve the following beneficial effects:

In the present disclosure, the rubber asphalt-derived VOCs inhibitor is an organic zirconium-based MOFs material. The material has a cubic crystal structure with a pore size of 0.5 nm to 2 nm. VOCs molecules collide with each other and squeeze into the internal pores of MOFs molecules, thus effectively absorbing rubber asphalt-derived VOCs molecules. Meanwhile, the relatively small pore size can prevent asphalt from getting inside and clogging the material. In addition, unsaturated metal Zr³⁺ ions in the MOFs material are unstable and active. When in contact with VOCs molecules, an electron cloud density of Zr³⁺ metal sites shifts, and part of the charge may be transferred to VOCs molecules to form chemical bonds, which can enhance the adsorption effect and have a high selectivity. This mechanism can significantly reduce the types and amounts of VOCs released from rubber asphalt, reduce environmental pollution caused during rubber asphalt construction, and promote the promotion and application of rubber asphalt.

Moreover, the specific surface area is in a range of 1,000 m²/g to 3,200 m²/g. The high specific surface area makes the material very compatible with asphalt. A ΔS value from the segregation test results of the MOFs material and asphalt is in a range of 0.4 to 0.8, which is far lower than that in the specification requirements. Asphalt is a complex organic mixture composed of saturated components, aromatic components, colloids, and asphaltenes, while a ligand of the MOFs material has an organic structure, such as terephthalic acid, biphenyl-4,4′-dicarboxylic acid, and [1,1′:3′,1″-terphenyl]-4,4″-dicarboxylic acid. According to the principle of similarity compatibility, the compatibility of this MOFs material with asphalt is better than that of inorganic materials.

In addition, due to the addition of rubber asphalt-derived VOCs inhibitor provided by the present disclosure, the smoke-suppression rubber asphalt provided by the present disclosure can reduce the type number of the rubber asphalt-derived VOCs from 87 to 20, lower concentrations of aliphatic hydrocarbons, aromatic hydrocarbons, and hydrocarbon derivatives by 60% to 82%, and lower a concentration of sulfur-containing compounds by 90%. Especially, the inhibitor shows a particularly-significant inhibitory effect on class I carcinogens, with an inhibition rate up to 92.4%. Therefore, this inhibitor can reduce the harm to human health during the construction of rubber asphalt, and exhibits broad market application prospects.

### BRIEF DESCRIPTION OF DRAWINGS

FIGS. 1A-1C show a microscopic surface appearance of the rubber asphalt-derived VOCs inhibitor based on a MOFs material; where

FIG. 1A shows the microscopic surface appearance of the rubber asphalt-derived VOCs inhibitor in Example 1; FIG. 1B shows the microscopic surface appearance of the rubber asphalt-derived VOCs inhibitor in Example 2; and FIG. 1C shows the microscopic surface appearance of the rubber asphalt-derived VOCs inhibitor in Example 3.

FIG. 2 shows the comparison for inhibitory effects of the smoke-suppression rubber asphalt of an embodiment of the present disclosure and an ordinary rubber asphalt on the release of class I carcinogens.

FIG. 3 shows the comparison of the smoke-suppression rubber asphalt of an embodiment of the present disclosure and the ordinary rubber asphalt in inhibiting the release of rubber asphalt-derived VOCs.

### DETAILED DESCRIPTION OF THE INVENTION

To make the objects, technical solutions and advantages of the present disclosure clearer and more comprehensible, the present disclosure will be further described below in detail in conjunction with embodiments. It should be understood that the specific embodiments described herein are only intended to explain the present disclosure and are not intended to limit the present disclosure. Further, the technical features involved in the various embodiments of the present disclosure described below may be combined with each other as long as they do not constitute a conflict with each other.

Metal-organic frameworks (MOFs) are coordination polymers with a three-dimensional pore structure. Generally, metal ions are used as connection sites and organic ligands are used as supports to form a spatial 3D extension structure. By introducing different metal ions and organic ligands to participate in the assembly of coordination polymers, the MOFs are obtained with different pore sizes and specific surface areas.

Currently, the most studied MOF is the zirconium-based MOFs material, which is mainly used in photocatalysts, gas storage, detection of ferric ions in water, and gas adsorption separation. For example, the zirconium-based MOFs material in Chinese patent CN113087918A is used to adsorb and separate carbon dioxide, propylene, and ethylene gases in the atmosphere, but shows a poor adsorption effect on volatile substances due to high pore size and low specific surface area (the pore size is in a range of 0.06 m to 5 m and the specific surface area is in a range of 600 m²/g to 1,300 m²/g). Moreover, there are few studies on the inhibition of rubber asphalt-derived VOCs by MOFs, such that the inhibitory effect on rubber asphalt-derived VOCs is not yet clear.

In this study, it has been found that a zirconium-based MOFs material with a cubic crystal structure by using any one of terephthalic acid, biphenyl-4,4′-dicarboxylic acid, and [1,1′:3′,1″-terphenyl]-4,4″-dicarboxylic acid as an organic ligand, and then adding zirconium chloride and the organic ligand at molar ratio of 1:(1-6). The zirconium-based MOFs material has a chemical formula of CₓH_{y}O₃₂Zr₆, where x is in a range of 48 to 120, and y is in a range of 28 to 76; and the zirconium-based MOFs material has a cubic structure with a pore size of 0.5 nm to 2 nm and a specific surface area of 1,000 m²/g to 3,200 m²/g. The material has a large specific surface area and desirable compatibility with rubber asphalt, and its low pore size can prevent asphalt from entering the material and clogging the pores. These characteristics are conducive to the targeted adsorption of volatile substances, thereby significantly reducing the number of VOCs in rubber asphalt (the VOCs concentration is reduced by 89.4%), especially significantly reducing the concentrations of aliphatic hydrocarbons, aromatic hydrocarbons, hydrocarbon derivatives, and sulfur-containing compounds. In particular, the material has a particularly-significant inhibitory effect on class I carcinogens such as 1,3-butadiene, benzene, trichlorethylene, and 1,2-dichloropropane, with an inhibition rate as high as 84% to 92.4%.

The present disclosure provides a rubber asphalt-derived VOCs inhibitor based on a MOFs material, which is a zirconium-based MOFs material, where the zirconium-based MOFs material has a chemical formula of CₓH_{y}O₃₂Zr₆, x being in a range of 48 to 120, and y being in a range of 28 to 76; and the zirconium-based MOFs material has a crystal pore size of 0.5 nm to 2 nm and a specific surface area of 1,000 m²/g to 3,200 m²/g.

In some embodiments, the zirconium-based MOFs material has a crystal appearance of small cubic crystals with a size of 100 nm to 3.0 μm, a pore size of 1 nm to 2 nm and a specific surface area of 2,000 m²/g to 3,200 m²/g.

The present disclosure further provides a method for preparing the rubber asphalt-derived VOCs inhibitor based on a MOFs material, including the following steps:

(1) Adding zirconium chloride into DMF, and stirring at a constant temperature to obtain a solution A, where the stirring is conducted at a constant temperature for example 60° C. for 15 min to 30 min, and the zirconium chloride and the DMF are added at a molar ratio of 1:(400-600).

(2) Adding an organic ligand at a preset ratio into the solution A, and stirring at a constant temperature to obtain a solution B; where the stirring is conducted at the constant temperature for example 60° C. for 15 min to 30 min to obtain the solution B; the preset ratio is a molar ratio of zirconium chloride to organic ligand being 1:(1-6); and the organic ligand includes one or a combination of two or more selected from the group consisting of terephthalic acid, biphenyl-4,4′-dicarboxylic acid, and [1,1′:3′,1″-terphenyl]-4,4″-dicarboxylic acid.

Through experiments, it has been found that a MOFs material can be prepared by zirconium chloride and an organic ligand at molar ratio of 1:(1-6), where any one of terephthalic acid, biphenyl-4,4′-dicarboxylic acid, and [1,1′:3′,1″-terphenyl]-4,4″-dicarboxylic acid is used as the organic ligand. The material has high pore size and high specific surface area, with a crystal pore size of 0.5 nm to 2 nm and a specific surface area of 1,000 m²/g to 3,200 m²/g. This material has strong adsorption capacity for rubber asphalt-derived VOCs, especially for 1,3-butadiene, benzene, trichlorethylene, and 1,2-dichloropropane. This indicates that the material can significantly inhibit the release of these class I carcinogens in rubber asphalt and reduce their damages to the human body.

In some embodiments, the terephthalic acid contains greater than or equal to 98.0 wt % of C₈H₆O₄, the biphenyl-4,4′-dicarboxylic acid contains greater than or equal to 97.0 wt % of C₁₄H₁₀O₄, and the [1,1′:3′,1″-terphenyl]-4,4″-dicarboxylic acid contains greater than or equal to 98.0 wt % of C₂₀H₁₄O₄; and the zirconium chloride contains greater than or equal to 99.8 wt % ZrCl₄.

(3) Adding a preset amount of acetic acid into the solution B at a constant flow rate of 1 mL/min to 10 mL/min, and stirring at a constant temperature to obtain a solution C; where the stirring is conducted at a constant temperature for example 60° C. for 30 min to 60 min; and the preset amount is based on a molar ratio of zirconium chloride to acetic acid at 1:(5-105).

In some embodiments, the acetic acid contains greater than or equal to 99.5 wt % of CH₃COOH.

(4) Transferring the solution C into a reactor, and conducting reaction at a temperature of 100° C. to 160° C. for 12 h to 24 h to obtain a reaction product; naturally cooling the reaction product to room temperature to obtain a solution D; subjecting the solution D to washing by centrifugation with DMF and methanol multiple times to obtain a precipitate, and drying the precipitate to obtain the rubber asphalt-derived VOCs inhibitor based on a MOFs material.

In some embodiments, the solution D is washed with DMF, specifically washed by centrifugation 2 to 3 times at a rotation speed of 6,000 rpm to 10,000 rpm, and then washed with methanol by centrifugation at a rotation speed of 6,000 rpm to 10,000 rpm for 2 to 3 times to obtain a precipitate. The precipitate is dried at a temperature of 60° C. to 80° C. for 12 h to 20 h, thereby producing a zirconium-based MOFs material, which is the rubber asphalt-derived VOCs inhibitor based on a MOFs material.

In addition, the present disclosure further provides use of the rubber asphalt-derived VOCs inhibitor based on a MOFs material, where the inhibitor is used to adsorb VOCs in rubber asphalt, especially to adsorb the rubber asphalt-derived VOCs of 1,3-butadiene, benzene, trichlorethylene, and 1,2-dichloropropane.

The present disclosure further provides a smoke-suppression rubber asphalt, including the following components in parts by mass: 70 parts to 90 parts of an asphalt, 10 parts to 30 parts of a rubber powder, and 0.1 parts to 1 part of the rubber asphalt-derived VOCs inhibitor based on a MOFs material.

In some embodiments, the smoke-suppression rubber asphalt is prepared by a method including the following steps:
heating the asphalt to a temperature of 160° C. to 170° C., shearing at the temperature of 160° C. to 170° C. and a shearing speed of 4,000 r/min to 8,000 r/min for 40 min to 60 min, and adding the rubber powder according to a ratio during the shearing to obtain a rubber asphalt; and
adding 0.1 parts to 1 part of the rubber asphalt-derived VOCs inhibitor based on a MOFs material provided by the present disclosure into the rubber asphalt, and shearing at a shearing speed of 4,000 r/min to 8,000 r/min for 20 min to 40 min at a temperature of 160° C. to 170° C. to obtain the smoke-suppression rubber asphalt.

Examples are as follows:

### Example 1 Rubber Asphalt-Derived VOCs Inhibitor 1 Based on a MOFs Material (C₄₈H₂₈O₃₂Zr₆)

The rubber asphalt-derived VOCs inhibitor 1 was named as UiO-66 with a chemical formula of C₄₈H₂₈O₃₂Zr₆, and was specifically prepared according to the following steps:
1) zirconium chloride was added to DMF according to a molar ratio of zirconium chloride to DMF at 1:600, and stirred at 60° C. for 15 min to obtain a solution A;
2) an organic ligand was added according to a molar ratio of the zirconium chloride to the organic ligand terephthalic acid at 1:1, that is, the terephthalic acid was added into the solution A and stirred at 60° C. for 15 min to obtain a solution B;
3) acetic acid was added according to a molar ratio of zirconium chloride to acetic acid at 1:5, where the acetic acid was added to the solution B at a constant flow rate of 2 mL/min, and then stirred at 60° C. for 30 min to obtain a solution C;
4) the solution C was transferred to a reactor, the reactor was sealed and placed at 120° C. for 20 h for reaction; and after the reaction was completed, a resulting product was naturally cooled to room temperature to obtain a solution D; and
5) the solution D was washed 2 times with DMF by centrifugation at a rotation speed of 6,000 rpm, and then washed 3 times with methanol by centrifugation at a rotation speed of 7,000 rpm to obtain a precipitate; and the precipitate was dried at 60° C. for 16 h to obtain a zirconium-based MOFs material, which was the rubber asphalt-derived VOCs inhibitor based on a MOFs material.

### Example 2 Rubber Asphalt-Derived VOCs Inhibitor 2 Based on a MOFs Material (C₈₄H₅₂O₃₂Zr₆)

The rubber asphalt-derived VOCs inhibitor was named as UiO-67 with a chemical formula of C₈₄H₅₂O₃₂Zr₆, and was specifically prepared according to the following steps:
1) zirconium chloride was added to DMF according to a molar ratio of zirconium chloride to DMF at 1:500, and stirred at 60° C. for 30 min to obtain a solution A;
2) an organic ligand was added according to a molar ratio of the zirconium chloride to the organic ligand biphenyl-4,4′-dicarboxylic acid at 1:3, that is, the biphenyl-4,4′-dicarboxylic acid was added into the solution A and stirred at 60° C. for 30 min to obtain a solution B;
3) acetic acid was added according to a molar ratio of zirconium chloride to acetic acid at 1:50, where the acetic acid was added to the solution B at a constant flow rate of 8 mL/min, and then stirred at 60° C. for 30 min to obtain a solution C;
4) the solution C was transferred to a reactor, the reactor was sealed and placed at 120° C. for 22 h for reaction; and after the reaction was completed, a resulting product was naturally cooled to room temperature to obtain a solution D; and
5) the solution D was washed 3 times with DMF by centrifugation at a rotation speed of 8,000 rpm, and then washed 3 times with methanol by centrifugation at a rotation speed of 8,000 rpm to obtain a precipitate; and the precipitate was dried at 80° C. for 18 h to obtain a zirconium-based MOFs material, which was the rubber asphalt-derived VOCs inhibitor based on a MOFs material.

### Example 3 Rubber Asphalt-Derived VOCs Inhibitor 3 Based on a MOFs Material (C₁₂₀H₇₆O₃₂Zr₆)

The rubber asphalt-derived VOCs inhibitor was named as UiO-68 with a chemical formula of C₁₂₀H₇₆O₃₂Zr₆, and was specifically prepared according to the following steps:
1) zirconium chloride was added to DMF according to a molar ratio of zirconium chloride to DMF at 1:400, and stirred at 60° C. for 25 min to obtain a solution A;
2) an organic ligand was added according to a molar ratio of the zirconium chloride to the organic ligand [1,1′:3′,1″-terphenyl]-4,4″-dicarboxylic acid at 1:5, that is, the [1,1′:3′,1″-terphenyl]-4,4″-dicarboxylic acid was added into the solution A and stirred at 60° C. for 25 min to obtain a solution B;
3) acetic acid was added according to a molar ratio of zirconium chloride to acetic acid at 1:105, where the acetic acid was added to the solution B at a constant flow rate of 6 mL/min, and then stirred at 60° C. for 20 min to obtain a solution C;
4) the solution C was transferred to a reactor, the reactor was sealed and placed at 120° C. for 24 h for reaction; and after the reaction was completed, a resulting product was naturally cooled to room temperature to obtain a solution D; and
5) the solution D was washed 3 times with DMF by centrifugation at a rotation speed of 8,000 rpm, and then washed 3 times with methanol by centrifugation at a rotation speed of 8,000 rpm to obtain a precipitate; and the precipitate was dried at 80° C. for 20 h to obtain a zirconium-based MOFs material, which was the rubber asphalt-derived VOCs inhibitor based on a MOFs material.

Determination of the microscopic appearance and specific surface area for rubber asphalt-derived VOCs inhibitor:

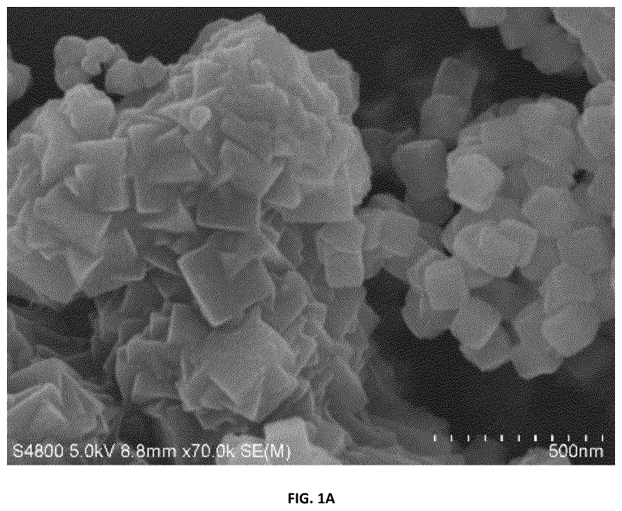

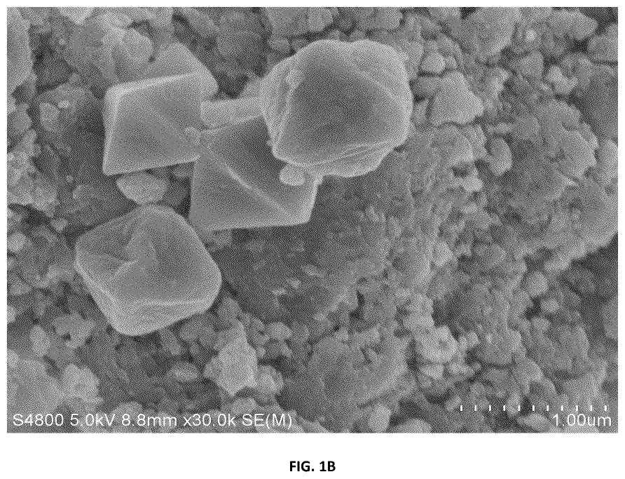

The rubber asphalt-derived VOCs inhibitors obtained according to Examples 1 to 3 were tested using a scanning electron microscope (SEM) and a fully-automatic rapid specific surface area and porosity analyzer. The test results are shown in FIGS. 1A-1C and Table 1, where FIG. 1A, FIG. 1B, and FIG. 1C are SEM images of the samples in Examples 1, 2, and 3, respectively.

TABLE 1

| | Specific surface | Pore | Pore |
|---|---|---|---|
| Sample | area (m²/g) | volume (cm³/g) | diameter (nm) |
| Example 1 | 1337 | 0.48 | 1.92 |
| Example 2 | 2108 | 1.03 | 1.71 |
| Example 3 | 3149 | 1.34 | 1.62 |

As shown in FIG. 1A, the crystal appearance of the sample of Example 1 is characterized as small cubic crystals of about 100 nm, the crystals are stacked, and there is agglomeration between the crystals.

As shown in FIG. 1B, the appearance of some crystals in the sample of Example 2 is relatively regular, with a crystal size of approximately 1.0 μm.

As shown in FIG. 1C, the appearance of the sample of Example 3 changes to a regular cube, the crystals are relatively dispersed without agglomeration, and has a crystal size of approximately 2.5 μm.

### Example 4 Smoke-Suppression Rubber Asphalt 1

This smoke-suppression rubber asphalt consisted of 79.4 parts of a 70 #matrix asphalt, 20 parts of a rubber powder, and 0.6 part of the rubber asphalt-derived VOCs inhibitor based on a MOFs material obtained according to Example 1, and was specifically prepared according to the following steps:

79.4 parts of the matrix asphalt was heated to a temperature of 160° C. and sheared at the temperature of 160° C. and a shearing speed of 4,000 r/min for 45 min, and during the shearing, 20 parts of the rubber powder was added. 0.6 part of the rubber asphalt-derived VOCs inhibitor based on a MOFs material obtained according to Example 1 was added to the rubber asphalt, and sheared at a high rotation speed of 6,000 r/min for 20 min at a temperature of 170° C., to obtain the smoke-suppression rubber asphalt.

### Example 5 Smoke-Suppression Rubber Asphalt 2

This smoke-suppression rubber asphalt consisted of 81.4 parts of a 70 #matrix asphalt, 18 parts of a rubber powder, and 0.6 part of the rubber asphalt-derived VOCs inhibitor based on a MOFs material obtained according to Example 2, and was specifically prepared according to the following steps:

81.4 parts of the matrix asphalt was heated to a temperature of 160° C. and sheared at the temperature of 160° C. and a rotation speed of 6,000 r/min for 40 min, during the shearing, 18 parts of the rubber powder was added. 0.6 part of the rubber asphalt-derived VOCs inhibitor based on a MOFs material obtained according to Example 2 was added to the rubber asphalt, and sheared at a high rotation speed of 6,000 r/min for 30 min at a temperature of 170° C., to obtain the smoke-suppression rubber asphalt.

### Example 6 Smoke-Suppression Rubber Asphalt 3

This smoke-suppression rubber asphalt consisted of 77.4 parts of a 70 #matrix asphalt, 22 parts of a rubber powder, and 0.6 part of the rubber asphalt-derived VOCs inhibitor based on a MOFs material obtained according to Example 3, and was specifically prepared according to the following steps:

77.4 parts of the matrix asphalt was heated to a temperature of 160° C. and sheared at the temperature of 160° C. and a rotation speed of 8000 r/min for 40 min, and during the shearing, 22 parts of the rubber powder was added. 0.6 part of the rubber asphalt-derived VOCs inhibitor based on a MOFs material obtained according to Example 3 was added to the rubber asphalt, and sheared at a high rotation speed of 8,000 r/min for 30 min at a temperature of 170° C., to obtain the smoke-suppression rubber asphalt.

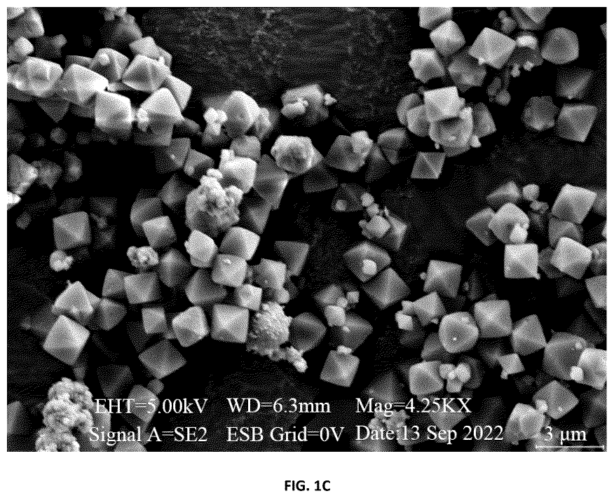

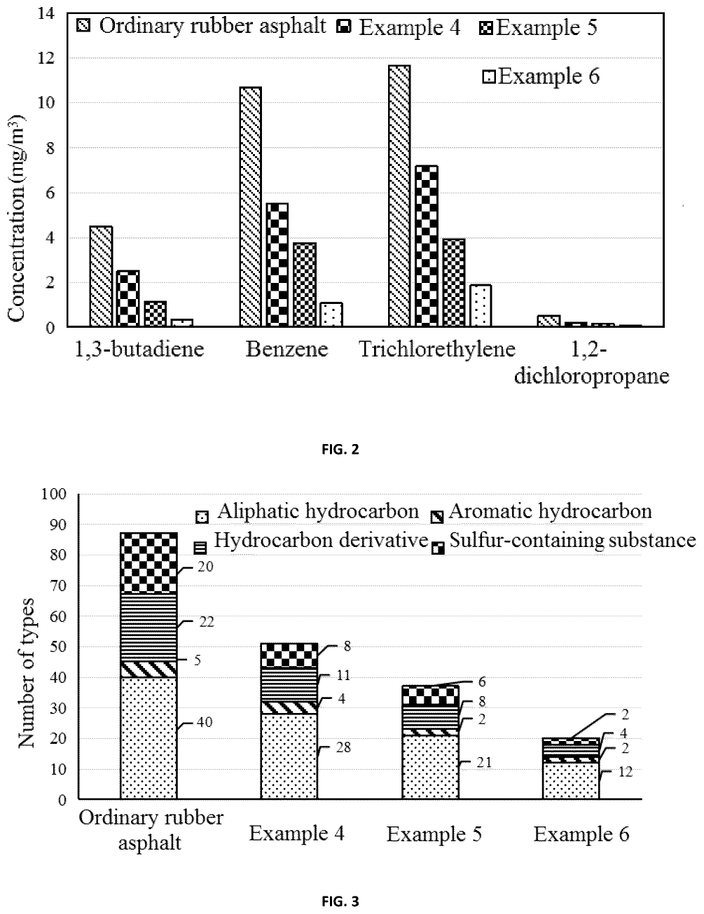

The VOCs releases of an ordinary rubber asphalt and the smoke-suppression rubber asphalt based on MOFs material prepared according to Examples 4 to 6 were quantitatively analyzed and characterized using a gas chromatography-mass spectrometry (GC-MS). The ordinary rubber asphalt and the samples of the Examples 4 to 6 were heated in a heatable sealed container at 170° C. for 30 min, and two obtained gases were each collected in a gas collection bag and sent to GC-MS to detect VOCs content separately, thus evaluating the inhibitory effect of rubber asphalt-derived VOCs inhibitor based on a MOFs material on VOCs of a rubber powder. The test results are shown in Table 2 and FIG. 2 and FIG. 3.

TABLE 2

| Sample | VOCs concentration (mg/m³) |
|---|---|
| Ordinary rubber asphalt | 845.94 |
| Example 4 | 487.82 |
| Example 5 | 243.67 |
| Example 6 | 89.53 |

As shown in Table 2, the ordinary rubber asphalt and Examples 4, 5, and 6 has a total concentration of VOCs at 845.94, 487.82, 253.47, and 89.53 mg/m³, respectively. It can be calculated that the inhibition rates of rubber asphalt-derived VOCs by Examples 4, 5, and 6 are as high as 42.3%, 71.2%, and 89.4%, respectively. The sample of Example 6 shows the most significant inhibitory effect, mainly due to its higher specific surface area.

4 class I carcinogens were detected among more than 100 VOCs in asphalt, namely 1,3-butadiene, benzene, trichlorethylene, and 1,2-dichloropropane.

As shown in FIG. 2, compared with the ordinary rubber asphalt, in Examples 4, 5, and 6: the concentrations of 1,3-butadiene are reduced by 44.8%, 74.9%, and 92.4%, respectively; the concentrations of benzene are reduced by 48.5%, 65.0% and 90.1%, respectively; the concentrations of trichlorethylene are reduced by 38.5%, 66.3% and 84.1%, respectively; the concentrations of 2-dichloropropane are reduced by 58.0%, 72.0% and 89.4%, respectively. Sample of Example 6 shows the best inhibitory effect on the four class I carcinogens.

As shown in FIG. 3, aliphatic hydrocarbons are the main components of VOCs. For the ordinary rubber asphalt, samples of Examples 4, 5, and 6, the aliphatic hydrocarbon contents are 46.0%, 54.9%, 56.8%, and 60.0%, respectively; the aromatic hydrocarbon contents are the lowest, are 5.7%, 7.8%, 5.4%, and 10.0%, respectively. With incorporation of the rubber asphalt-derived VOCs inhibitor based on a MOFs material, the type number of asphalt-derived VOCs is reduced. For samples of Examples 4, 5, and 6, type numbers of the VOCs are reduced from 87 to 51, 37, and 20, respectively.

From this, it can be calculated that compared with ordinary rubber asphalt, in the smoke-suppression rubber asphalt samples of Examples 4, 5, and 6: the concentrations of aliphatic hydrocarbons are reduced by 30.0%, 47.5%, and 70.0%, respectively; the concentrations of aromatic hydrocarbons are reduced by 20.0%, 60.0%, and 60.0%, respectively; the concentrations of hydrocarbon derivatives are reduced by 50.0%, 63.6%, and 81.8%, respectively; the concentrations of sulfur-containing compounds are reduced by 60.0%, 70.0% and 90.0%, respectively. This indicates that the rubber asphalt-derived VOCs inhibitor based on a MOFs material provided by the present disclosure could effectively adsorb class I carcinogens and reduce the harm of class I carcinogens caused to the human body.

In summary, the rubber asphalt-derived VOCs inhibitor based on a MOFs material provided by the present disclosure has a high specific surface area, a controllable structure, and a functional adsorption capacity of specific functional group-containing substances. This inhibitor shows a VOCs inhibition rate reaching 89.4%, and a particularly-significant inhibitory effect on class I carcinogens up to 92.4%.

It is easy for those skilled in the art to understand that the above-mentioned contents are merely the preferred embodiments of the present disclosure, and are not intended to limit the present disclosure. Any modifications, equivalent substitutions and improvements made within the spirit and principles of the present disclosure shall fall within the scope of the present disclosure.

1. A rubber asphalt-derived volatile organic compounds (VOCs) inhibitor based on a metal organic frameworks (MOFs) material, wherein the rubber asphalt-derived VOCs inhibitor has a chemical formula of CₓH_{y}O₃₂Zr₆, x being in a range of 48 to 120, and y being in a range of 28 to 76; and the rubber asphalt-derived VOCs inhibitor is a zirconium-based MOFs material having a cubic crystal structure with a crystal pore size of 0.5 nm to 2 nm and a specific surface area of 1,000 m²/g to 3,200 m²/g.

2. The rubber asphalt-derived VOCs inhibitor based on the MOFs material of claim 1, wherein the zirconium-based MOFs material has a crystal appearance with a size of 100 nm to 3.0 μm, the crystal pore size of 1 nm to 2 nm, and the specific surface area of 2,000 m²/g to 3,200 m²/g.

3. A method for preparing the rubber asphalt-derived VOCs inhibitor based on the MOFs material of claim 1, comprising the following steps:
adding zirconium chloride into N,N-dimethylformamide (DMF), stirring at a constant temperature, separately adding an organic ligand and acetic acid, and stirring at a constant temperature to obtain a mixed solution; and
subjecting the mixed solution to reaction at a temperature of 100° C. to 160° C. for 12 h to 24 h to obtain a reaction product, and naturally cooling the reaction product to room temperature;
washing the reaction product by centrifugation with DMF and methanol multiple times to obtain a precipitate, and drying the precipitate to obtain the rubber asphalt-derived VOCs inhibitor based on a MOFs material; wherein
the zirconium chloride, the DMF, the organic ligand, and the acetic acid are added at a molar ratio of 1:(400-600):(1-6):(5-105); and
the organic ligand comprises one or a combination of two or more selected from the group consisting of terephthalic acid, biphenyl-4,4′-dicarboxylic acid, and [1,1′:3′,1″-terphenyl]-4,4″-dicarboxylic acid.

4. The method of claim 3, wherein the terephthalic acid contains greater than or equal to 98.0 wt % of C₈H₆O₄, the biphenyl-4,4′-dicarboxylic acid contains greater than or equal to 97.0 wt % of C₁₄H₁₀O₄, and the [1,1′:3′,1″-terphenyl]-4,4″-dicarboxylic acid contains greater than or equal to 98.0 wt % of C₂₀H₁₄O₄; and the acetic acid contains greater than or equal to 99.5 wt % of CH₃COOH.

5. The method of claim 3, wherein the acetic acid is added at a flow rate of 1 mL/min to 10 mL/min.

6. The method of claim 3, wherein when the zirconium chloride is added into the DMF, the stirring is conducted at the constant temperature of 30° C. to 80° C. for 15 min to 30 min; when the organic ligand is added, the stirring is conducted at the constant temperature of 20° C. to 60° C. for 15 min to 30 min; and when the acetic acid is added, the stirring is conducted at the constant temperature of 40° C. to 60° C. for 30 min to 60 min.

7. The method of claim 3, wherein the zirconium-based MOFs material has a crystal appearance with a size of 100 nm to 3.0 μm, the crystal pore size of 1 nm to 2 nm, and the specific surface area of 2,000 m²/g to 3,200 m²/g.

8. The method of claim 5, wherein when the zirconium chloride is added into the DMF, the stirring is conducted at the constant temperature of 30° C. to 80° C. for 15 min to 30 min; when the organic ligand is added, the stirring is conducted at the constant temperature of 20° C. to 60° C. for 15 min to 30 min; and when the acetic acid is added, the stirring is conducted at the constant temperature of 40° C. to 60° C. for 30 min to 60 min.

9. A smoke-suppression rubber asphalt, comprising the following components in parts by mass: 70 parts to 90 parts of an asphalt, 10 parts to 30 parts of a rubber powder, and 0.1 parts to 1 part of the rubber asphalt-derived VOCs inhibitor based on the MOFs material of claim 1.

10. The smoke-suppression rubber asphalt of claim 9, wherein the smoke-suppression rubber asphalt is prepared by a method comprising the following steps:
mixing 70 parts to 90 parts of the asphalt at a temperature of 160° C. to 170° C. as a matrix with 10 parts to 30 parts of the rubber powder, and shearing at a shearing speed of 4,000 r/min to 8,000 r/min for 40 min to 60 min to obtain a rubber asphalt; and
adding 0.1 parts to 1 part of the rubber asphalt-derived VOCs inhibitor based on the MOFs material into the rubber asphalt, and shearing at a shearing speed of 4,000 r/min to 8,000 r/min for 20 min to 40 min at a constant temperature of 160° C. to 170° C. to obtain the smoke-suppression rubber asphalt.

11. The smoke-suppression rubber asphalt of claim 9, wherein the zirconium-based MOFs material has a crystal appearance with a size of 100 nm to 3.0 μm, the crystal pore size of 1 nm to 2 nm, and the specific surface area of 2,000 m²/g to 3,200 m²/g.

12. The smoke-suppression rubber asphalt of claim 10, wherein the zirconium-based MOFs material has a crystal appearance with a size of 100 nm to 3.0 μm, the crystal pore size of 1 nm to 2 nm, and the specific surface area of 2,000 m²/g to 3,200 m²/g.
